(19) United States
(12) Patent Application Publication
(10) Pub. No.: US 2016/0314480 A1
(43) Pub. Date: Oct. 27, 2016

(54) Synchronization of Iterative Methods for Solving Optimization Problems with Concurrent Methods for Forecasting in Stream Computing

(71) Applicant: International Business Machines Corporation, Armonk, NY (US)

(72) Inventors: Jakub Marecek, Dublin (IE); Martin Mevissen, Dublin (IE); Pascal Pompey, Nanterre (FR); Mathieu Sinn, Dublin (IE)

(21) Appl. No.: 14/694,055

(22) Filed: Apr. 23, 2015

(51) Int. Cl. G06Q 30/02

(52) U.S. Cl. CPC G06Q 30/0202

(57) ABSTRACT

A mechanism is provided for synchronization of concurrent optimization and forecasting. A change between current forecast input data most recently received from a forecasting mechanism and forecast input data used in a current iterative execution of a mechanism for solving optimization problems is estimated with respect to the objective function employed in the optimization problem. A threshold is estimated by evaluating the progress of the mechanism for solving optimization problems in a current execution. A determination is made as to whether the change is greater than or equal to the threshold. Responsive to the change being greater than or equal to the threshold, further computation by the mechanism for solving optimization problems is canceled, restarted, or rescheduled. Responsive to the change being less than the threshold, computation by the sensitivity-aware scheduler is allowed to continue.

### BACKGROUND

The present application relates generally to an improved data processing apparatus and method and more specifically to mechanisms for synchronization of iterative methods for solving optimization problems with concurrent methods for forecasting in stream computing.

Data from sources such as market data, Internet of Things, mobile, sensors, clickstream, and even certain transactions, remain largely un-navigated. In rapidly changing data, stream computing enables organizations to detect risks and opportunities, which are relevant only for a very short period. Stream computing captures, analyzes, and acts on such risks and opportunities before opportunities are lost, with very low latency. Stream computing also makes it possible to deal with amounts of data so large that they cannot be stored and move from batch-processing to near real-time analytics and decisions. Overall, stream computing continuously integrates and analyzes data in motion to deliver near real-time analytics.

Stream computing is important to many applications, where both forecasting and optimization may be performed. Consider, for example, power systems, where important decisions hinge on which generators to turn on and off and how to set the voltages, under constraints on power-flow feasibility. The Federal Energy Regulatory Commission (FERC) estimates that the value of a one percent improvement in a particular decision has a market value of 1 to 4 billion dollars per annum in the U.S. alone. The optimum decision is based on forecasts of demand, supply from renewables, and exchange prices, and may take minutes or hours to find, whereas new forecasts of future loads may be available every second or millisecond, as current demands are metered and weather data are recorded. Dealing with stream-processing operations at such different time-scales is a major challenge.

### SUMMARY

In one illustrative embodiment, a method, in a data processing system, is provided for synchronization of concurrent optimization and forecasting. The illustrative embodiment estimates a change between current forecast input data most recently received from a forecasting mechanism and forecast input data used in a current iterative execution of a mechanism for solving optimization problems, with respect to the objective function employed in the optimization problem. The illustrative embodiment estimates a threshold by evaluating the progress of the mechanism for solving optimization problems in a current execution. The illustrative embodiment determines whether the change is greater than or equal to the threshold. The illustrative embodiment cancels, restarts, or reschedules further computation by the mechanism for solving optimization problems in response to the change being greater than or equal to the threshold. The illustrative embodiment allows computation by the sensitivity-aware scheduler to continue in response to the change being less than the threshold.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented:

FIG. 3 depicts a functional block diagram of a sensitivity-aware scheduling mechanism for synchronization of concurrent optimization and forecasting in stream computing in accordance with an illustrative embodiment;

FIG. 4 depicts an exemplary flowchart of the operation performed in a stream computing system in synchronization of iterative methods for solving optimization problems with concurrent methods for forecasting in stream computing in accordance with an illustrative embodiment; and

FIG. 5 depicts another exemplary flowchart of the operation performed in a stream computing system in synchronization of iterative methods for solving optimization problems with concurrent methods for forecasting in stream computing in accordance with an illustrative embodiment.

### DETAILED DESCRIPTION

The illustrative embodiments provide a synchronization mechanism for a pair of stream-processing methods in a consumer-producer relationship. The producer (e.g. a forecasting mechanism) produces data. The consumer (e.g. a mechanism for solving optimization problems) consumes the data and runs iteratively, but asynchronously on a different time-scale, while allowing some progress information to be extracted. The synchronization mechanism provides means of canceling and/or rescheduling the run of the consumer by analyzing both the progress of iterates of the consumer and the availability and qualities of more recent data provided by the producer.

In the following, the illustrative embodiments focus on the setting, where the producer is a forecasting mechanism and the consumer is a mechanism for solving optimization problems. The particular quantity of interest in the example will be the change of the objective of the optimization problem as a result of the change of the input data from the forecasting mechanism, hereinafter referred to as sensitivity. The sensitivity may be quantified in different manners and may be bounded both in general and in an application-specific manner. This illustrative embodiment utilizes a sensitivity-analysis mechanism to identify this sensitivity and utilize a sensitivity-aware scheduler for controlling the mechanism for solving optimization problems based on bounds for the sensitivity identified by the sensitivity analysis mechanism.

Before beginning the discussion of the various aspects of the illustrative embodiments, it should first be appreciated that throughout this description the term “mechanism” will be used to refer to elements of the present invention that perform various operations, functions, and the like. A “mechanism.” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

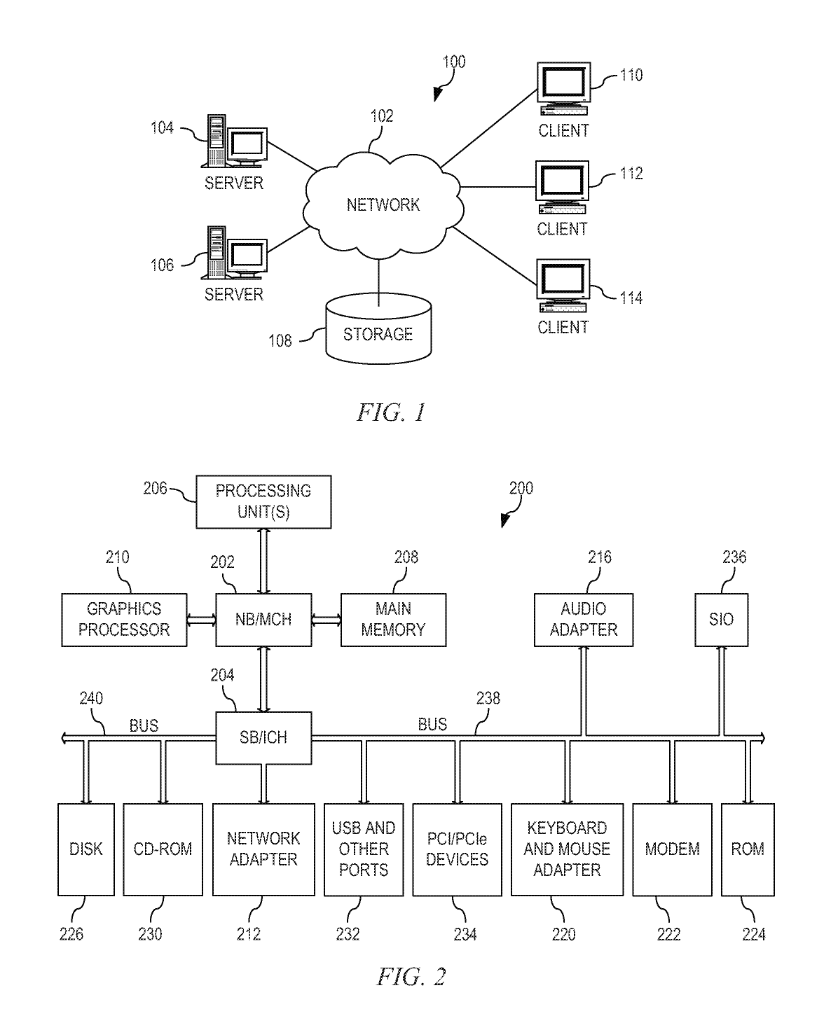

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

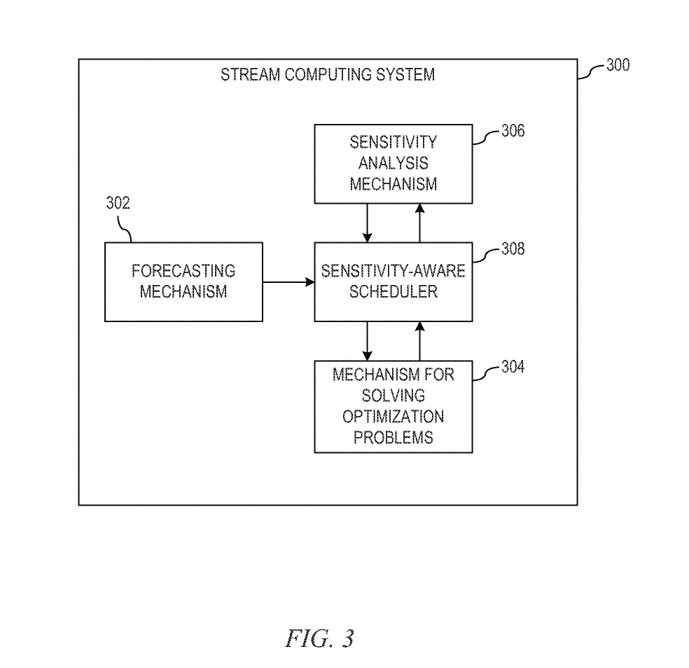

FIG. 3 depicts a functional block diagram of a sensitivity-aware scheduling mechanism for synchronization of concurrent optimization and forecasting in stream computing in accordance with an illustrative embodiment. Stream computing system 300, which may be a data processing system such as data processing system 200 of FIG. 2, comprises forecasting mechanism 302, mechanism for solving optimization problems 304, sensitivity analysis mechanism 306, and sensitivity-aware scheduler 308. As stream computing system 300 operates, in time periods i=1, 2, . . . , forecasting mechanism 302 generates forecast input data in the form of, for example, a vector AiεRⁿ and a scalar biεR for each time period and forwards the vector Ai and the scalar hi to sensitivity-aware scheduler 308. Sensitivity-aware scheduler 308 concatenates the input data received from forecasting mechanism 302 in the past i time periods into a matrix (A, b) εRⁱ×(n+11) and sends the data to mechanism for solving optimization problems 304. The mechanism for solving optimization problems 304 utilizes the forecast input data in the matrix (A, b) to find a solution. However, due to the dimensions of the matrix (A,b), mechanism for solving optimization problems 304 may take much longer than one time period for some LεN and i>>L, which is some point from which the optimization becomes more expensive than the forecasting. The run-time of the optimization algorithm will grow with i⁷/100 time-periods, for instance, whereas the run-time of the forecasting mechanism will be constant at one time period. For low i, the optimization will be faster than the forecasting, but that will change with the growth of i. Consider, for example, the instance where the optimization problem is the least squares, i.e., finding an x such that ∥Ax−b∥2 is minimized. Finding the least squares solution (A^{-T}A)⁻¹A^{-T}b) is possible in time O(n²i), when A and b are fixed and known. When the run-time O(n²i) is (much) larger than a single period and new vector Ai and the scalar bi are generated every time period, the best that may be performed is to track the solution to the least-squares problem with the most recent A, b as closely as possible. That is, mechanism for solving optimization problems 304 runs iteratively in hopes to produce a sequence of x′i, which would track the true xi as closely as possible, in terms of the Euclidean norm. L₂. A simple implementation of the consumer may use only a pre-determined number of most recent rows in matrix (A,b), but the computation performed by mechanism for solving optimization problems 304 may still take d time periods. If computation is run every r time periods, where the natural choices are r≈d (in a “single thread” setting) and r=1 (in parallel computing), the most recently obtained least-squares estimate may use forecast input data up to r+(d−1) time-periods old.

Under assumptions that the vector AiεRⁿ is a random variable, independently and identically distributed, it is possible to show the following mechanism performs well. Sensitivity analysis mechanism 306 compares the L2 norm of the difference of the most recent scalar bi obtained from forecasting mechanism 302 and the one-but-next-most-recent scalar bi−1 received from forecasting mechanism 302 and iteratively run by mechanism for solving optimization problems 304 against a predetermined threshold tεR. Thus, if sensitivity analysis mechanism 306 determines that |bi−bi−1|≧t, sensitivity analysis mechanism 306 instructs sensitivity-aware scheduler 308 to stop any further computation by mechanism for solving optimization problems 304. Conversely, if sensitivity analysis mechanism 306 determines that |bi−bi−1|<t, sensitivity analysis mechanism 306 instructs sensitivity-aware scheduler 308 to let mechanism for solving optimization problems 304 continue computation.

Therefore, sensitivity analysis mechanism 306 estimates the difference between the forecast input data most recently provided by forecasting mechanism 302 and the forecast input data used in the current iterative execution by mechanism for solving optimization problems 304 to identify changes. Sensitivity analysis mechanism 306 estimates the effects of changes on the output of mechanism for solving optimization problems 304 so as to limit of the number of iterations thereby providing the sensitivity. That is, sensitivity analysis mechanism 306 estimates the progress of mechanism for solving optimization problems 304 at the current iteration based on the forecast input data received from forecasting mechanism 302 to determine whether a convergence has been or is close to being solved. Thus, sensitivity analysis mechanism 306 takes into account the sensitivity analysis and convergence to cancel, (re)schedule, or continue to execute mechanism for solving optimization problems 304.

In a slightly more elaborate version of the example, instead of computing (A^{-T}A)⁻¹A^{-T}b) directly using Cholesky decomposition, one could use Givens transformations or similar iterative methods for computing the so called QR decomposition. Instead of a predetermined threshold tεR, one could subsequently use a threshold based on the progress of the current iterate. Such elaboration is best illustrated in more complex settings.

In order to understand the operations performed by the sensitivity-aware scheduling mechanism of the illustrative embodiments, consider, for example, the following. According to the International Energy Association, there are 22,126 TWh of electric power generated world-wide annually, at a huge cost. Clearly, minimizing the costs of generating the energy, while satisfying the demands of the customers (referred to as the load), would be beneficial.

Therefore, forecasting mechanism 302 utilizes:
a hierarchical model of the demand for electric power and power flows, i.e., mathematically speaking a directed acyclic graph, where vertices with in-degree of 0 (“roots of the trees”) are power stations and vertices with out-degree of 0 (“leaves”) are customers, where the vertices, which are neither roots nor leaves, represent substations, bus-bars, etc., and the edges are oriented according to the flow of electrical current;
current bounds on the generation at each power generating station;
limits on the energy usage of each customer;
real-time updates on the current usage of energy by each customer; and/or
real-time updates on the weather in the geographical area including all the positions of all customers and power stations,
   to predict:
future usage of energy by each customer; and/or
future bounds on the generation at each power station, especially from renewable sources but also due to maintenance, etc.

Utilizing the data provided by forecasting mechanism 302, sensitivity analysis mechanism 306 aggregates the load at each vertex of the hierarchical model of the current power flow, except for the leaves, and compares only the changes in the aggregates, summed or whose increasing functions are summed, rather than the values of the loads at the leaves. This means that, for example, if one customer stops boiling water in their kettle and their next door neighbor starts boiling water, the aggregate will not change from the point of view identified by sensitivity analysis mechanism 306, provided both the customer and the next door neighbor are coupled to a same substation.

Mechanism for solving optimization problems 304 utilizes:
estimates of future bounds on the generation at each power station;
estimates of future energy usage of each customer; and/or
data about the customer connections and power stations and the transmission and/or distribution network that connects them, in terms of power lines and switch gear,
   to produce:
decisions on powering on and off of individual blocks of power stations at times in the future (“unit commitment”); and/or
hierarchical models of future power flows.

Therefore, utilizing the sensitivity identified by sensitivity analysis mechanism 306 and the decisions and hierarchical models from mechanism for solving optimization problems 304, sensitivity-aware scheduler 308 stops mechanism for solving optimization problems 304 from further computation, when the change in the aggregates exceeds a threshold, either pre-determined or based on the progress of the mechanism for solving optimization problems. Sensitivity-aware scheduler 308 instructs mechanism for solving optimization problems 304 to continue computation, when the change in the aggregates does not exceed a threshold, either pre-determined or based on the progress of the mechanism for solving optimization problems.

The description of the present embodiments is presented for purposes of illustration, and is not intended to be exhaustive. One may consider, for instance,
alternating-current transmission constraints, an approximation thereof, or no transmission constraints in the mechanism for solving optimization problems;
constraints on the amount of power to be generated from hydro valleys in the mechanism for solving optimization problems;
constraints related to maintenance of power stations in the mechanism for solving optimization problems; and/or
cloud cover and further covariates in the forecasting mechanism.

In order to further illustrate the operations performed by the sensitivity-aware scheduling mechanism, consider, as a further example, the cloud computing. According to Forrester Research, the global cloud computing market is expected to reach $241 billion by the year 2020. The key question on the part of a cloud computing provider is the assignment of workload to the physical machines. Clearly, one hopes to minimize the energy use (and hence the number of physical machines in use) and the number of migrations of virtual machines across physical machines, while satisfying the quality-of-service guarantees.

Therefore, forecasting mechanism 302 utilizes:
profiles of physical machines;
partition of physical machines to data centers;
configurations of virtual machines in terms of limits on the usage of processor time, memory, networking, etc.;
real-time updates on the current usage of processor time, memory, networking, etc., for each virtual machine;
real-time updates on the current networking traffic for each virtual machine, especially locations of the other communicating parties; and/or
current mappings of virtual machines to physical machines,
   to predict:
future profiles of virtual machines in terms of usage of processor time, memory, networking, etc.; and/or
future profiles of virtual machines in terms of current networking traffic, especially the location of the other communicating parties.

Sensitivity analysis mechanism 306 partitions the virtual machines into classes of the equivalence given by the configuration and the preferred data center. Sensitivity analysis mechanism 306 only uses the number of changes of the cardinality of the partitions (class of the equivalence), rather than the actual virtual machines, such that:
for virtual machines that have a defined preferred data center, sensitivity analysis mechanism 306 considers the total number of virtual machines of one configuration (e.g. big-memory, big-traffic) and of one preferred data center, and
for the remaining virtual machines that do not have a defined preferred data center because the network traffic comes from many geographical areas, sensitivity analysis mechanism 306 considers the total number of virtual machines of one configuration (e.g. big-memory, big-traffic).

This means that if there is one virtual machine of a particular configuration with preferred location L is removed and another virtual machine, of the same configuration with preferred location L, is created, sensitivity analysis mechanism 306 will instruct sensitivity-aware scheduler 308 to let mechanism for solving optimization problems 304 continue computation. However, if a particular configuration with preferred location L is removed and no other virtual machine having the same configuration with preferred location L is created, then sensitivity analysis mechanism 306 instructs sensitivity-aware scheduler 308 to stop mechanism for solving optimization problems 304 from further computation as nothing has changed, in principle, although they may belong to different customers and may run different programs.

In another embodiment, in periods i=1, 2, . . . , forecasting mechanism 302 again generates forecast input data that aids in optimizing a particular product or service. Sensitivity-aware scheduler 308 formulates the instance of the optimization problem utilizing the forecast input data from forecasting mechanism 302 and sends the data to mechanism for solving optimization problems 304. That is, utilizing the forecast input data, mechanism for solving optimization problems 304 formulates and solves:

minimize f₀(x) (1)

subject to fᵢ(x)≦0, iε{1 . . . ,m} (2)

hᵢ(x)=0, iε{1, . . . ,p} (3)

whose inputs (i.e. coefficients in functions fi and hi) are based on forecast input data received from forecasting mechanism 302. Utilizing data received after each iteration from mechanism for solving optimization problems 304 as well as the most recent forecast input data from forecasting mechanism 302, sensitivity analysis mechanism 306 analyzes a Lagrangian function of the instance to estimate the sensitivity e, which is mathematical function:

$$Λ ( x , λ , v ) = {f}_{0} ( x ) + {\sum }_{i = 1}^{m} {λ}_{i} {f}_{i} ( x ) + {\sum }_{i = 1}^{p} {v}_{i} {h}_{i} ( x ) \qquad ( 4 )$$

where ν and λ are the dual variables as well as a Lagrange dual function:

$$g ( λ , v ) = {inf}_{x ∈ D} ( {f}_{0} ( x ) + {\sum }_{i = 1}^{m} {λ}_{i} {f}_{i} ( x ) + {\sum }_{i = 1}^{p} {v}_{i} {h}_{i} ( x ) ) . \qquad ( 5 )$$

The illustrative embodiments denote the global optimum of the optimization problem (1-3) by p* and denote any solution satisfying constraints (2-3) of the optimization problem (1-3) by s. For any λ≧0, ν, mechanism for solving optimization problems 304 has Lagrange function g(λ, ν)≦p*. For any solution s, which satisfies the constraints (2-3), mechanism for solving optimization problems 304 has f0(s)≧p*. Using such upper and lower bounds, sensitivity analysis mechanism 306 bounds the gap g_{d} between the optimum (best feasible solution s) and the current iterate.

Thus, sensitivity analysis mechanism 306 computes a threshold t using g_{d} that is either an upper or lower bound on ∥p*i−p*i+1∥_{q} for some (semi-)norm given by q, such as 2 or ∞, where p*i is the value of the objective function at the global optimum for the particular f0, fi, and hi, which are available at time i and p*i+1 is the value of the objective function at the global optimum for the particular f0, fi, and hi, which are available at time i+1, or an upper or lower bound on ∥z*i−z*i+1∥_{q} for some (semi-)norm given by q, such as 2 or ∞, where z*i is the actual global optimum for the particular f0, fi, and hi, which are available at time i, and z*i+1 is the actual global optimum for the particular f0, fi, and hi, which are available at time i+1. A number of particular bounding techniques may be utilized. For example, consider integral solutions to a system of linear constraints, which matter in the case of unit commitment, where reactors are either on or off. Considering a bound on the Lx norm of sensitivity, let A be an integral m×n matrix, such that each sub-determinant of vector A is at most Δ(A) in absolute value, and let b′, b″, and w be vectors such that Ax≦b′ and Ax≦b″ have integral solution and max {wx: Ax≦b′} and max {w: Ax≦b″ } exist. Then for each optimum z′ to max {wx: Ax≦b′, x integral} there exists an optimum of z″ to max{wx: ax≦b″, x integral} with ∈=∥z′−z″∥∞≦nΔ(A)(∥b′−b″∥∞+2). Sensitivity analysis mechanism 306 determines whether the threshold t is less than or equal to the sensitivity ∈, which is a measure of progress of the solver. If t≦∈, sensitivity analysis mechanism 306 would instruct sensitivity-aware scheduler 308 to restart or (re)schedule mechanism for solving optimization problems 304 with a new input. If t>∈, sensitivity analysis mechanism 306 would instruct sensitivity-aware scheduler 308 to let mechanism for solving optimization problems 304 continue computation. The tests may change lightly, if sensitivity analysis mechanism 306 produces an upper bound (p*i, p*i+1)≧δ.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

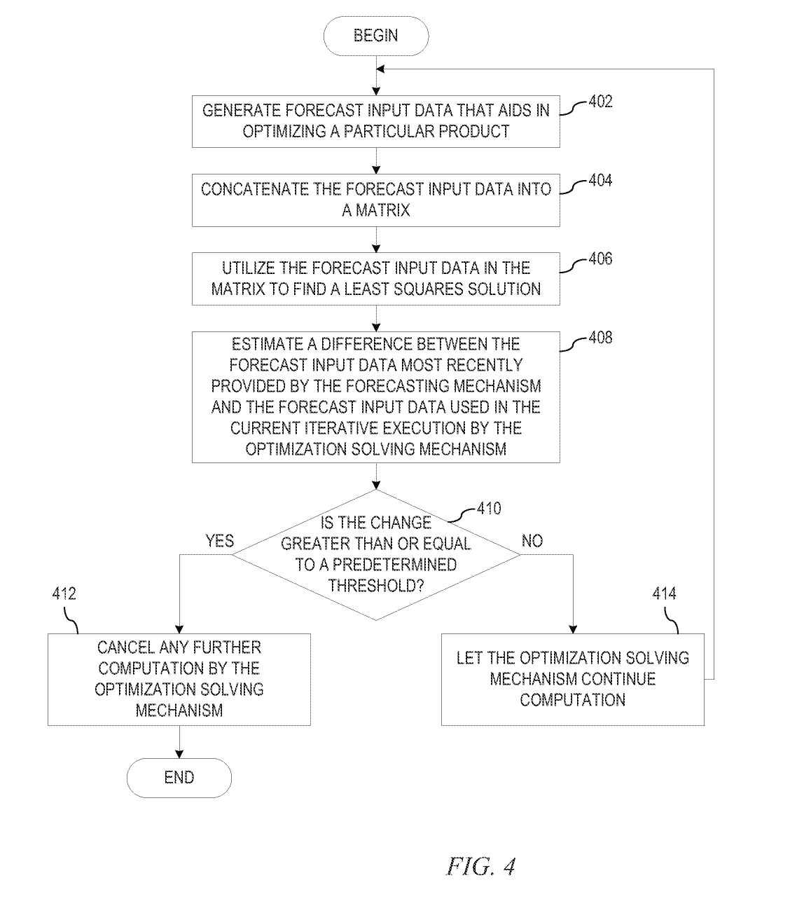

FIG. 4 depicts an exemplary flowchart of the operation performed in a stream computing system in synchronization of iterative methods for solving optimization problems with concurrent methods for forecasting in stream computing in accordance with an illustrative embodiment. As the operation begins, in each time period in a set of time periods, a forecasting mechanism generates forecast input data that aids in optimizing a particular product (step 402). A sensitivity-aware scheduler concatenates the forecast input data into a matrix (step 404). A mechanism for solving optimization problems then utilizes the forecast input data in the matrix to find a least squares solution (step 406).

Utilizing the forecast input data most recently provided by the forecasting mechanism and the forecast input data used in the current iterative execution by the mechanism for solving optimization problems, a sensitivity analysis mechanism estimates a difference between the forecast input data most recently provided by the forecasting mechanism and the forecast input data used in the current iterative execution by the mechanism for solving optimization problems (i.e., a change) (step 408). Utilizing the change, the sensitivity analysis mechanism determines whether the change is greater than or equal to a predetermined threshold (step 410). If at step 410 the sensitivity analysis mechanism determines that the change is greater than or equal to a predetermined threshold, the sensitivity analysis mechanism instructs a sensitivity-aware scheduler to cancel any further computation by the mechanism for solving optimization problems (step 412), with the operation terminating thereafter. Conversely, if at step 410 the sensitivity analysis mechanism determines that the change is less than the predetermined threshold, the sensitivity analysis mechanism instructs a sensitivity-aware scheduler to let the mechanism for solving optimization problems continue computation (step 414), with the operation returning to step 402.

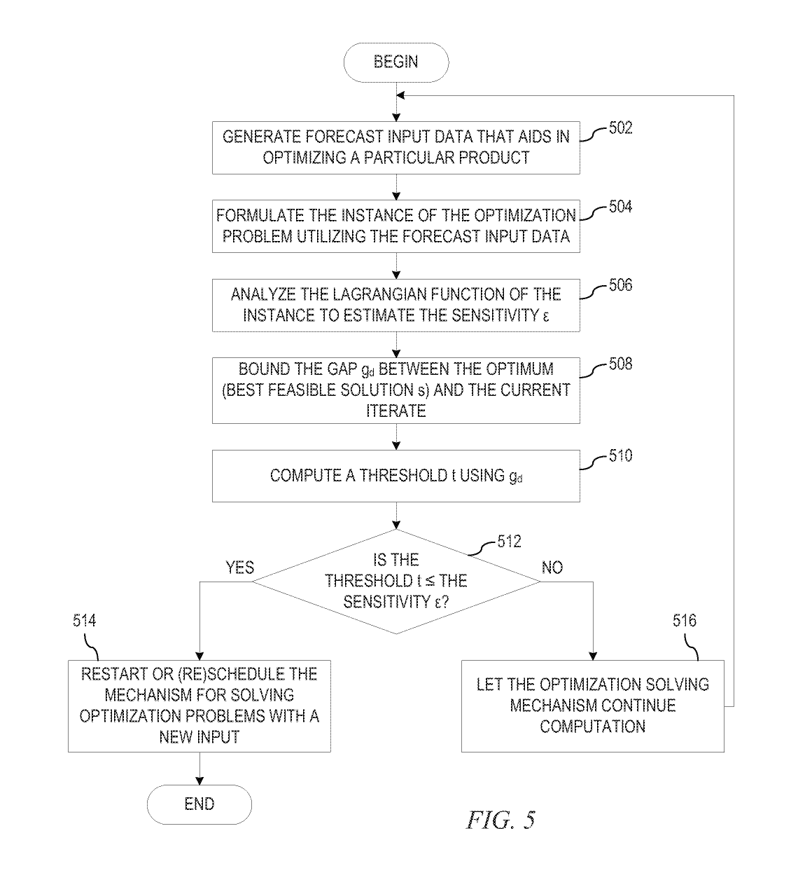

FIG. 5 depicts another exemplary flowchart of the operation performed in a stream computing system in synchronization of iterative methods for solving optimization problems with concurrent methods for forecasting in stream computing in accordance with an illustrative embodiment. As the operation begins, in each time period in a set of time periods, a forecasting mechanism generates forecast input data that aids in optimizing a particular product (step 502). A sensitivity-aware scheduler formulates the instance of the optimization problem utilizing the forecast input data (step 504). That is, a mechanism for solving optimization problems utilizes the forecast data to formulate and solve:

minimize f₀(x) (6)

subject to fᵢ(x)≦0, iε{1, . . . ,m} (7)

hᵢ(x)=0, iε{1, . . . ,p} (8)

whose inputs (i.e. coefficients in functions fi and hi) are based on forecast input data received from the forecasting mechanism. Utilizing data received after each iteration from the mechanism for solving optimization problems as well as the most recent forecast input data from the forecasting mechanism, a sensitivity analysis mechanism analyzes the Lagrangian function of the instance to estimate the sensitivity c (step 506), which is mathematical function:

$$Λ ( x , λ , v ) = {f}_{0} ( x ) + {\sum }_{i = 1}^{m} {λ}_{i} {f}_{i} ( x ) + {\sum }_{i = 1}^{p} {v}_{i} {h}_{i} ( x ) \qquad ( 9 )$$

where ν and λ are the dual variables as well as a Lagrange dual function:

$$g ( λ , v ) = {inf}_{x ∈ D} ( {f}_{0} ( x ) + {\sum }_{i = 1}^{m} {λ}_{i} {f}_{i} ( x ) + {\sum }_{i = 1}^{p} {v}_{i} {h}_{i} ( x ) ) . \qquad ( 10 )$$

The illustrative embodiments denote the global optimum of the optimization problem (6-8) by p* and denote any solution satisfying constraints (2-3) of the optimization problem (6-8) by s. For any λ≧0, ν, mechanism for solving optimization problems 304 has Lagrange function g(λ, ν)≦p*. For any solution s, which satisfies the constraints (7-8), the mechanism for solving optimization problems has f0(s)≧p*. Using such upper and lower bounds, the sensitivity analysis mechanism bounds the gap g_{d} between the optimum (best feasible solution s) and the current iterate (step 508).

Thus, the sensitivity analysis mechanism computes a threshold t using g_{d} (step 510) that is either an upper or lower bound on ∥p*ᵢ−p*ᵢ₊₁∥_{q} for some (semi-)norm given by q, such as 2 or ∞, where p*ᵢ is the value of the objective function at the global optimum for the particular f₀, fᵢ, and hᵢ, which are available at time i and p*ᵢ₊₁, is the value of the objective function at the global optimum for the particular f₀, fᵢ, and hᵢ, which are available at time i+1, or an upper or lower bound on ∥z*ᵢ−z*ᵢ₊₁∥_{q} for some (semi-)norm given by q, such as 2 or ∞, where z*ᵢ is the actual global optimum for the particular f₀, fᵢ, and hᵢ, which are available at time i, and z*ᵢ₊₁ is the actual global optimum for the particular f₀, fᵢ, and hᵢ, which are available at time i+1. A number of particular bounding techniques may be utilized. For example, consider integral solutions to a system of linear constraints, which matter in the case of unit commitment, where reactors are either on or off. Considering a bound on the L_{∞} norm of sensitivity, let A be an integral m×n matrix, such that each sub-determinant of vector A is at most Δ(A) in absolute value, and let b′, b″, and w be vectors such that Ax≦b′ and Ax≦b″ have integral solution and max {w: Ax≦b′} and max {x: Ax≦b″ } exist. Then for each optimum z′ to max {x: Ax≦b′, x integral} there exists an optimum of z″ to max {wx: ax≦b″, x integral} with ∈=∥z′−z″∥_{∞}≦nΔ(AX)(∥b′−b″∥_{∞}+2).

The sensitivity analysis mechanism then determines whether the threshold t is less than or equal to the sensitivity ∈ (step 512) which is a measure of progress of the solver. If at step 512 the sensitivity aware mechanism determines that t≦∈, the sensitivity analysis mechanism instructs the sensitivity-aware scheduler to restart or (re)schedule the mechanism for solving optimization problems with a new input (step 514), with the operation terminating thereafter. If at step 512 the sensitivity aware mechanism determines that t>∈, the sensitivity analysis mechanism instructs sensitivity-aware scheduler to let the mechanism for solving optimization problems continue computation (step 516), with the operation returning to step 502. The tests may change lightly, if the sensitivity analysis mechanism produces an upper bound (p*ᵢ, p*ᵢ₊₁)≧δ.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for synchronization of concurrent optimization and forecasting. By analyzing both the progress of iterates of the mechanism for solving optimization problems and the availability and qualities of more recent data provided by the forecasting mechanism, the illustrative embodiments provide for canceling, rescheduling, or continuing the optimization being performed by the mechanism for solving optimization problems based on a sensitivity that may be quantified in different manners and may be bounded both in general and in an application-specific manner. Therefore, the illustrative embodiments enables constant and timely updates of the optimal plan, enables to spread over time the computational workload linked with updating the solution to an optimal strategy, and enables tracking not only of a system state (control, statistics, streams processing) but also of a linked optimal plan.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application, or technical improvement over technologies found in the marketplace, or to enable others of ordinary skill in the art to understand the embodiments disclosed herein.

1-8. (canceled)

9. A computer program product comprising a computer readable storage medium having a computer readable program stored therein, wherein the computer readable program, when executed on a computing device, causes the computing device to:
estimate a change between current forecast input data most recently received from a forecasting mechanism and forecast input data used in a current iterative execution of a mechanism for solving optimization problems, with respect to the objective function employed in the optimization problem;
estimate a threshold by evaluating the progress of the mechanism for solving optimization problems in a current execution;
determine whether the change is greater than or equal to the threshold;
responsive to the change being greater than or equal to the threshold, cancel, restart, or reschedule further computation by the mechanism for solving optimization problems; and
responsive to the change being less than the threshold, allow computation by the sensitivity-aware scheduler to continue.

10. The computer program product of claim 9, wherein the current forecast input data most recently received from the forecasting mechanism and the forecast input data used in the current iterative execution of the mechanism for solving optimization problems of the form minimize f0,(x) subject to fᵢ(x)≦bᵢ, iε{1, . . . ,m} are in the form of a vector bεR^{m} with element b_{b} iε{1, . . . ,m}, and coefficients of multi-variate polynomials f₀, fᵢ, iε{1, . . . ,m}.

11. The computer program product of claim 10, wherein an update of the output of the forecasting requires updating only certain elements of a matrix, which is the input to the mechanism for solving optimization problems, and which represents elements bᵢ, iε{1, . . . ,m} and coefficients of multi-variate polynomials f₀, fᵢ, iε{1, . . . ,m}.

12. The computer program product of claim 10, wherein an update of the output of the forecasting requires updating only certain elements of the matrix, which are used within the mechanism for solving optimization problems and which are derived prior to the execution of the iterative method from the matrix, which represents elements bᵢ, iε{1, . . . ,m}, and coefficients of multi-variate polynomials f₀, fᵢ, iε{1, . . . ,m}.

13. The computer program product of claim 9, wherein the current forecast input data most recently received from the forecasting mechanism and the forecast input data used in the current iterative execution of the mechanism for solving optimization problems of the form minimize f₀(x) subject to fᵢ(x)≦bᵢ, iε{1, . . . ,m} are in the form of a vector bεR^{m} with elements bᵢ, iε{1, . . . ,m}.

14. The computer program product of claim 9, wherein the mechanism for solving optimization problems is an iterative method and the progress of the mechanism for solving optimization problems is estimated by the analysis of the current iterate.

15. An apparatus comprising:
a processor; and
a memory coupled to the processor, wherein the memory comprises instructions which, when executed by the processor, cause the processor to:
estimate a change between current forecast input data most recently received from a forecasting mechanism and forecast input data used in a current iterative execution of a mechanism for solving optimization problems, with respect to the objective function employed in the optimization problem;
estimate a threshold by evaluating the progress of the mechanism for solving optimization problems in a current execution;
determine whether the change is greater than or equal to the threshold;
responsive to the change being greater than or equal to the threshold, cancel, restart, reschedule further computation by the mechanism for solving optimization problems; and
responsive to the change being less than the threshold, allow computation by the sensitivity-aware scheduler to continue.

16. The apparatus of claim 15, wherein the current forecast input data most recently received from the forecasting mechanism and the forecast input data used in the current iterative execution of the mechanism for solving optimization problems of the form minimize f₀,(x) subject to fᵢ(x)≦bᵢ, iε{1, . . . ,m} are in the form of a vector bεR^{m} with element bᵢ, iε{1, . . . ,m}, and coefficients of multi-variate polynomials f₀, fᵢ, iε{1, . . . ,m}.

17. The apparatus of claim 16, wherein an update of the output of the forecasting requires updating only certain elements of a matrix, which is the input to the mechanism for solving optimization problems, and which represents elements b_{b} iε{1, . . . ,m} and coefficients of multi-variate polynomials f₀, fᵢ, iε{1, . . . ,m}.

18. The apparatus of claim 16, wherein an update of the output of the forecasting requires updating only certain elements of the matrix, which are used within the mechanism for solving optimization problems and which are derived prior to the execution of the iterative method from the matrix, which represents elements bᵢ, iε{1, . . . ,m}, and coefficients of multi-variate polynomials f₀, fᵢ, iε{1, . . . ,m}.

19. The apparatus of claim 15, wherein the current forecast input data most recently received from the forecasting mechanism and the forecast input data used in the current iterative execution of the mechanism for solving optimization problems of the form minimize f₀(x) subject to fᵢ(x)≦bᵢ, iε{1, . . . ,m} are in the form of a vector bεR^{m} with elements bᵢ, iε{1, . . . ,m}.

20. The apparatus of claim 15, wherein the mechanism for solving optimization problems is an iterative method and the progress of the mechanism for solving optimization problems is estimated by the analysis of the current iterate.

21. The apparatus of claim 20, wherein the mechanism for solving optimization problems comprises a primal-dual method and the progress of the mechanism for solving optimization problems is a function of the primal-dual gap.

22. The apparatus of claim 21, wherein the mechanism for solving optimization problems comprises a branch-and-bound method and the progress of the mechanism for solving optimization problems is a function of the gap between the present best bound and the present best feasible solution found so far.

23. The computer program product of claim 14, wherein the mechanism for solving optimization problems comprises a primal-dual method and the progress of the mechanism for solving optimization problems is a function of the primal-dual gap.

24. The computer program product of claim 23, wherein the mechanism for solving optimization problems comprises a branch-and-bound method and the progress of the mechanism for solving optimization problems is a function of the gap between the present best bound and the present best feasible solution found so far.
